(19) United States
(12) Patent Application Publication
(10) Pub. No.: US 2025/0058373 A1
(43) Pub. Date: Feb. 20, 2025

(54) BINDER FOR MOLDING CASTING MOLD AND COMPOSITION FOR MOLDING CASTING MOLD

(71) Applicant: SINTOKOGIO, LTD., Nagoya-shi (JP)

(72) Inventors: Kazuyuki NISHIKAWA, Nagoya-shi (JP); Yusuke Kato, Nagoya-shi (JP); Tomohiro Aoki, Nagoya-shi (JP); Toshihiko Zenpo, Nagoya-shi (JP); Tetsuji Matsui, Nagoya-shi (JP)

(73) Assignee: SINTOKOGIO, LTD., Nagoya-shi (JP)

(21) Appl. No.: 18/784,997

(22) Filed: Jul. 26, 2024

(30) Foreign Application Priority Data
Aug. 14, 2023 (JP) 2023-131830

(51) Int. Cl. B22C 1/18; B22C 1/02; C04B 14/04; C04B 28/00; C04B 103/63; C04B 111/28

(52) U.S. Cl. CPC B22C 1/188; B22C 1/02; C04B 14/041; C04B 28/008; C04B 2103/63; C04B 2111/28

(57) ABSTRACT

There is provided a binder for molding a casting mold, which contains water glass and aluminum silicate obtained by carrying out dissolution in the water glass, where the binder for molding a casting mold contains 2 to 15 parts by mass of the aluminum silicate with respect to 100 parts by mass of a solid content of the water glass.

### CROSS-REFERENCE TO RELATED APPLICATION

This application is based on Japanese Patent Application No. 2023-131830 filed with Japan Patent Office on Aug. 14, 2023, the entire contents of which are hereby incorporated by reference.

### TECHNICAL FIELD

The present disclosure relates to a binder for molding a casting mold and a composition for a molding casting mold.

### BACKGROUND

A water glass binder that generates little odor during molding or pouring is known as a binder for manufacturing a casting product. As such a water glass binder, a water glass binder that contains a water glass solution, and a natural and/or synthetic additive having a particle size of less than 5 μm, has been studied (see, for example, Patent Document 1). Patent Document 1: Japanese Unexamined Patent Publication No. 2016-533275

### SUMMARY

In the related art, attempts have been made to use a granular additive, thereby suppressing the precipitation of the additives in a binder. However, since the additive is merely dispersed in the binder, it is inevitable that some precipitation of the additive will occur during storage.

The present disclosure has been made in consideration of the above circumstances, and an object of the present invention is to provide a binder for molding a casting mold, which has excellent storage stability over a long period of time.

In addition, another object of the present disclosure is to provide a composition for molding a casting mold, which contains the binder for molding a casting mold.

A binder for molding a casting mold according to one aspect of the present disclosure is a binder that contains water glass and aluminum silicate dissolved in the water glass, where the binder for molding a casting mold contains 2 to 15 parts by mass of the aluminum silicate with respect to 100 parts by mass of a solid content of the water glass.

According to the present disclosure, there is provided a binder for molding a casting mold, which has excellent storage stability over a long period of time.

In addition, according to the present disclosure, there is provided a composition for molding a casting mold, which contains the binder for molding a casting mold.

### BRIEF DESCRIPTION OF THE DRAWINGS

FIG. 1A is a cross-sectional view showing a dimensional configuration of a casting mold.

FIG. 1B is a cross-sectional view showing the dimensional configuration of the casting mold.

FIG. 1C is a cross-sectional view showing an amount of deformation of a casting.

FIG. 2 is a graph showing a relationship between the presence or absence of addition of aluminum silicate to a water glass binder and the amount of deformation of the through hole.

### DETAILED DESCRIPTION

### Overview of Embodiment of Present Disclosure

An embodiment according to the present disclosure includes, for example, the following aspects.

[1] A binder for molding a casting mold, comprising:
water glass, and:
   aluminum silicate dissolved in the water glass,
   wherein the binder for molding a casting mold contains 2 to 15 parts by mass of the aluminum silicate with respect to 100 parts by mass of a solid content of the water glass.

[2] The binder for molding a casting mold, according to [1], wherein the binder for molding a casting mold contains 40% to 55% by mass of the solid content of the water glass and the aluminum silicate.

[3] The binder for molding a casting mold, according to [1] or [2], wherein the aluminum silicate is synthetic aluminum silicate.

[4] A composition for molding a casting mold, comprising:
fireproof inorganic particles and:
the binder for molding a casting mold according to any one of [1] to [3].

Hereinafter, suitable embodiments according to the present disclosure will be described in detail. However, the present disclosure is not limited to the following embodiments.

### <Binder for Molding a Casting Mold>

A binder for molding a casting mold contains water glass and aluminum silicate dissolved in the water glass. Hereinafter, the binder for molding a casting mold may be simply referred to as a binder.

Water glass is an aqueous solution in which an alkali silicate is dissolved, and the alkali silicate is, for example, a compound represented by General Formula xSiO₂·yM₂O·zH_{2O} (where M is an alkali metal which is Na, K, Li, or the like). Among the above, sodium silicates (silicates of soda) such as Na₂SiO₃, Na SiO₄, NazSi₂O₅, and Na₂Si₄O₉ can be suitably used as the alkali silicate from the viewpoint of high marketability and low cost. These sodium silicates are classified into kinds of No. 1 to No. 5 as follows according to the molar ratio of SiO₂/Na₂O. However, in addition to the sodium silicates of No. 1 to No. 5 below, sodium metasilicate having a molar ratio of SiO₂/Na₂O of 1.0 can also be used. These sodium (meth)silicates are commercially available and easily available.
No. 1: The molar ratio of SiO₂/Na₂O is 2.0 to 2.3.
No. 2: The molar ratio of SiO₂/Na₂O is 2.4 to 2.5.
No. 3: The molar ratio of SiO₂/Na₂O is 3.1 to 3.3.
No. 4: The molar ratio of SiO₂/Na₂O is 3.3 to 3.5.
No. 5: The molar ratio of SiO₂/Na₂O is 3.6 to 3.8.

It is possible to adjust the molar ratio of SiO₂/Na₂O by mixing these sodium silicates.

Although the amount of the free alkali hydroxide increases in a case where the molar ratio of SiO₂/Na₂O decreases, the molar ratio thereof is preferably 3.3 or less, more preferably 3.0 or less, and still more preferably 2.5 or less, from the viewpoint of the solubility of aluminum silicate. That is, in the above classification of sodium silicate, a sodium silicate having a small classification number can be used more suitably.

The solid content of water glass refers to the nonvolatile content (water glass component) obtained by removing water from water glass, and specifically, it is equivalent to a water-soluble alkali silicate such as sodium silicate. The amount of solid content in the water glass is adjusted according to the molar ratio of the water glass and the like; however, it is possible to add moisture and adjust viscosity in order to facilitate handling in a method of supplying a binder during molding a casting mold.

The aluminum silicate used herein is, for example, a compound having a general formula represented by Al₂(SiO₃)₃·nH₂O (n: 2 to 3) (KISHIDA CHEMICAL Co., Ltd.) or Al₂(SiO₃)₃ (FUJIFILM Corporation), and it is so-called synthetic aluminum silicate. In a case where synthetic aluminum silicate is used as the aluminum silicate, it is possible to suppress the deformation of the casting mold since not only a one-pack type liquid binder can be obtained but also heat resistance is excellent.

The amount of aluminum silicate with respect to 100 parts by mass of the solid content of water glass in the binder is 2 parts by mass or more from the viewpoint of improving the heat resistance of the binder; however, it is preferably 4 parts by mass or more.

On the other hand, the amount of the aluminum silicate is 15 parts by mass or less from the viewpoint of the solubility of aluminum silicate, the handleability of the binder, and the like; however, it is preferably 10 parts by mass or less.

The amount of the solid content of water glass and the amount of aluminum silicate in the binder is preferably 40% by mass or more and more preferably 43% by mass or more from the viewpoint of the moldability of the casting mold and the like.

On the other hand, the amount is preferably 55% by mass or less and more preferably 50% by mass or less from the viewpoint of kneading properties with respect to the aggregate.

The binder can be prepared by dissolving aluminum silicate in water glass. A method of preparing the binder is not particularly limited as long as the dissolution of aluminum silicate in water glass is achieved;

however, examples thereof include a method of dissolving aluminum silicate while heating water glass. In this case, it is preferable to use particles as fine as possible as aluminum silicate from the viewpoint of improving the solubility of aluminum silicate.

### <Composition for Molding Casting Mold>

The composition for molding a casting mold can contain a curing agent represented by propylene carbonate for acting with the binder for molding a casting mold and the fireproof inorganic particles, as well as the binder, to carry out the casting mold molding, or an exothermic agent represented by ferrosilicon that reacts with water glass to generate heat.

It is noted that, without containing these agents in the composition for molding a casting mold, it is also possible to carry out the casting mold molding by subjecting the binder to neutralized gelation by using an acid gas represented by carbon dioxide gas (a core molding method 2 described below).

### (Fireproof Inorganic Particle)

The fireproof inorganic particle (fireproof aggregate) includes a natural sand containing, as a main component, inorganic oxides such as a silicon oxide and an aluminum oxide, or an artificial sand containing these as a main component. The particle size of the fireproof inorganic particle is preferably 30 to 120 and more preferably 50 to 100 in terms of the AFS particle size index. In a casting that places importance on the casting surface, it is preferable that the fireproof inorganic particle has a certain fineness. On the other hand, in preventing gas defects and the like of the casting, it is preferable that, in general, the fireproof inorganic particle has a certain roughness in order to the ensure air permeability of the casting mold.

The amount of the binder in the composition for molding a casting mold is preferably 0.1 to 10 parts by mass and more preferably 1 to 5 parts by mass with respect to 100 parts by mass of the fireproof inorganic particles. The binder affects the strength of the casting mold. The amount of the binder can be appropriately adjusted according to the particle size and particle shape of the fireproof inorganic particles to be used. In a case where sufficient (for example, 1 MPa or more) strength of the casting mold is intended to be obtained, it is preferable to increase the amount of the binder to some extent since the surface area of particles increases in a case where fine fireproof inorganic particles are used. In addition, in a case where coarse fireproof inorganic particles or fireproof inorganic particles having a high sphericity are used, the surface area of the particles is smaller, and thus it is possible to reduce the amount of the binder to some extent.

### (Curing Agent)

The composition for molding a casting mold can contain a curing agent for accelerating the curing of the composition for molding a casting mold. As the curing agent, a curing agent represented by propylene carbonate that undergoes ester bonding with water glass can be used. The curing agent is used in a core molding method 1 described below.

The amount of the curing agent in the composition for molding a casting mold is preferably 0.05 to 5.0 parts by mass and more preferably 0.1 to 1.0 parts by mass with respect to 100 parts by mass of the fireproof inorganic particles.

### (Exothermic Accelerator)

The composition for molding a casting mold can contain an exothermic accelerator represented by metallic silicon or ferrosilicon. The exothermic accelerator can be used in a core molding method 3 described below.

The amount of the exothermic accelerator in the composition for molding a casting mold is preferably 0.5 to 5.0 parts by mass and more preferably 1.0 to 3.0 parts by mass with respect to 100 parts by mass of the fireproof inorganic particles.

The composition for molding a casting mold can be obtained by mixing the binder for molding a casting mold, the fireproof inorganic particles, and, as necessary, another component such as a curing agent, with a mixer or the like.

### Examples

Hereinafter, the present disclosure will be described in more detail according to Examples. However, the present disclosure is not limited to these examples.

### <Preparation of Binder (Binder for Molding Casting Mold)>

A predetermined amount of water glass No. 1 (manufactured by Fuji Chemical Co., Ltd., solid content: 48% by mass) and a synthetic aluminum silicate powder (manufactured by KISHIDA CHEMICAL Co., Ltd.) were charged into a 1 L glass beaker. Then, the glass beaker was installed on an 80° C. heating plate, and stirring was carried out with a tabletop stirrer to dissolve the aluminum silicate powder. As a result, a water glass binder according to the present disclosure, which contains aluminum silicate obtained by carrying out dissolution in the water glass No. 1, was prepared.

The water glass binder contained 5.2 parts by mass of aluminum silicate with respect to 100 parts by mass of the solid content (alkali silicate) of the water glass No. 1, and contained, in total, 49.3% by mass of the solid content of the water glass No. 1 and the aluminum silicate.

According to the visual observation immediately after the preparation, the water glass binder was transparent, and an aluminum silicate powder in a state of being dispersed in the binder was not observed.

The water glass binder according to the present disclosure remained transparent after 200 days in a room at about 25° C., and a sediment of aluminum silicate was not observed.

On the other hand, as a result of preparing a water glass binder in the same manner as described above by using the water glass No. 1 (manufactured by Fuji Chemical Co., Ltd.) and a white powder of anhydrous aluminum silicate (SP33 manufactured by BASF SE, which is not a synthetic aluminum silicate powder), a transparent water glass binder was not obtained. A dispersed aluminum silicate powder was observed in the binder. In addition, a sediment of aluminum silicate was observed after 200 days in a room at 25° C.

As described above, it has been found that the water glass binder according to the present disclosure has excellent storage stability over a long period of time.

### <Core Molding>

Next, using the water glass binder according to the present disclosure prepared as described above, a composition for core molding was prepared to carry out core molding. In the core molding, the water glass binder according to the present disclosure was used after being allowed to stand in a room at 25° C. for 30 days or more. In addition, the following three kinds of fireproof aggregates (sands) were prepared.
ESPEARL 60L (manufactured by YAMAKAWA SANGYO CO., LTD.)
NAIGAI CERABEADS 650 (manufactured by ITOCHU CERATECH CORPORATION)
MIKAWA R5.5 (manufactured by MIKAWA KEISEKI Co., Ltd.)

### (Core Molding Method 1: Curing Agent Curing Casting Mold)

A certain amount of the fireproof aggregate was charged into a mixer (manufactured by AICOHSHA MFG. CO., LTD., KENMIX), and then a prescribed amount (0.5 parts by mass with respect to 100 parts by mass of aggregate) of a propylene carbonate liquid (Azuchi Sangyo Co., Ltd.) was added thereinto, and then kneading was carried out for 1 minute. A prescribed amount (3.0 parts by mass for 100 parts by mass of aggregate) of the water glass binder according to the present disclosure was charged thereinto, and then kneading was further carried out for 1 minute. Thereafter, the kneaded material (composition for core molding) was taken out from the mixer, filled into a cast for core molding (core size: 15 mm×20 mm×159 mm, five pieces), pushed to be compacted, allowed to stand for 24 hours, and then de-molded to obtain a core 1.

On the other hand, a core 1C was obtained in the same manner as described above, except that the water glass No. 1 was used instead of the water glass binder according to the present disclosure.

### (Core Molding Method 2: Carbon Dioxide Curing Casting Mold)

A certain amount of the fireproof aggregate was charged into a mixer, and then a prescribed amount (3.0 parts by mass for 100 parts by mass of aggregate) of the water glass binder according to the present disclosure was charged thereinto, followed by kneading for 1 minute. Then, the kneaded material was taken out from the mixer, filled into a cast for core molding, and pushed to be compacted. Next, carbon dioxide gas was introduced into the cast through a pipe of a carbon dioxide cylinder for about 3 minutes, and demolding was carried out after being allowed to stand for 24 hours, thereby obtaining a core 2.

On the other hand, a core 2C was obtained in the same manner as described above, except that the water glass No. 1 was used instead of the water glass binder according to the present disclosure.

### (Core Molding Method 3: Exothermic Curing Casting Mold)

A certain amount of the fireproof aggregate was charged into a mixer, and then a prescribed amount (3.0 parts by mass with respect to 100 parts by mass of aggregate) of a ferrosilicon powder (manufactured by Kanto Metal Corporation) was charged thereinto, followed by kneading for 1 minute. A prescribed amount (3.0 parts by mass for 100 parts by mass of aggregate) of the water glass binder according to the present disclosure was charged thereinto, and then kneading was further carried out for 1 minute. Thereafter, the kneaded material was taken out from the mixer, filled into a cast for core molding, pushed to be compacted, allowed to stand for 24 hours, and then de-molded to obtain a core 3.

On the other hand, a core 3C was obtained in the same manner as described above, except that the water glass No. 1 was used instead of the water glass binder according to the present disclosure.

### <Casting Test>

Next, a casting test was carried out using the cores 1 to 3 or the cores 1C to 3C, which were obtained in the core molding method 1 to 3.

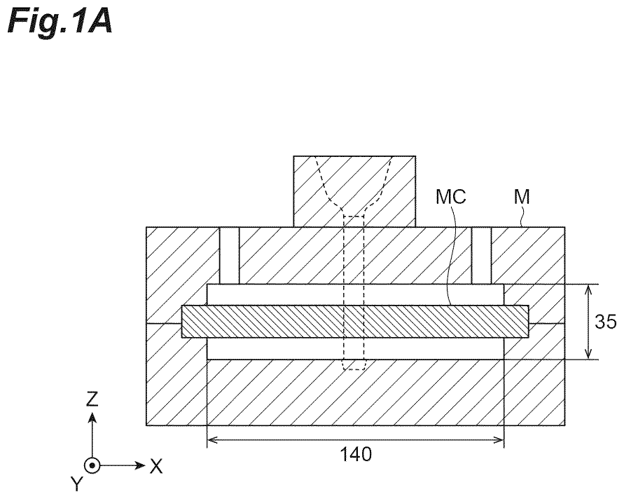

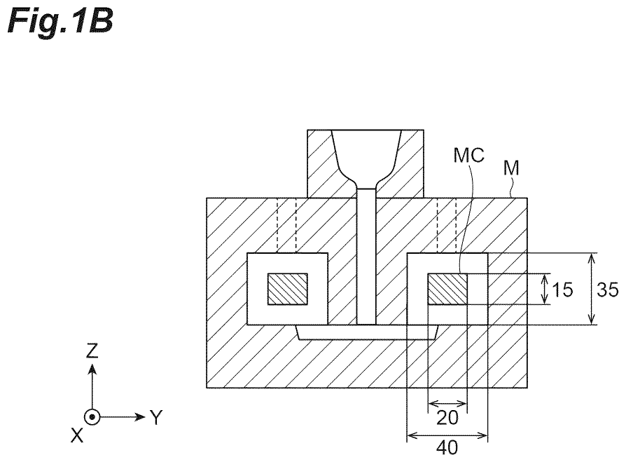

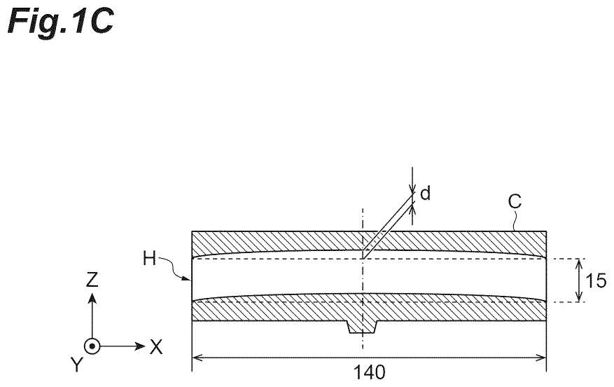

FIG. 1A is a cross-sectional view showing a dimensional configuration of a casting mold M. FIG. 1A is a cross-sectional view of the casting mold M in a case of being viewed in a Y direction. The Y direction is along the lateral direction of the casting mold M.

FIG. 1B is a cross-sectional view showing a dimensional configuration of a casting mold M. FIG. 1B is a cross-sectional view of the casting mold M in a case of being viewed in an X direction orthogonal to the Y direction. The X direction is along the longitudinal direction of the casting mold M.

FIG. 1C is a cross-sectional view showing an amount of deformation of a casting C. FIG. 1C is a cross-sectional view of the casting C in a case of being viewed in the Y direction.

As shown in FIGS. 1A and 1B, the casting mold M includes an upper mold, a lower mold, and a core MC.

The casting C shown in FIG. 1C was formed by pouring gray cast iron (FC250) into the casting mold M. The temperature of the molten metal at the time of pouring was 1,400° C.

As shown in FIG. 1C, the casting C has a rectangular parallelepiped shape. In the casting C, a through hole H that penetrates through the casting C along the X direction is formed. The through hole H is a portion that is formed by the core MC. The length of the casting C in the X direction was 140 mm, the length thereof in the Z direction was 35 mm, and the length thereof in the Y direction was 40 mm. The length of the through hole H in the Z direction was 15 mm, and the length thereof in the Y direction was 20 mm.

As shown in FIG. 1C, an amount of deformation d of the through hole H in the Z direction was measured for each of the cores 1 to 3 or cores 1C to 3C used. The amount of deformation d is the maximum width between the edge of the opening portion of the through hole H in the Z direction and the edge of the central part of the through hole H in the Z direction. The amount of deformation d corresponds to the amount of deformation of the core MC of the casting C in the Z direction.

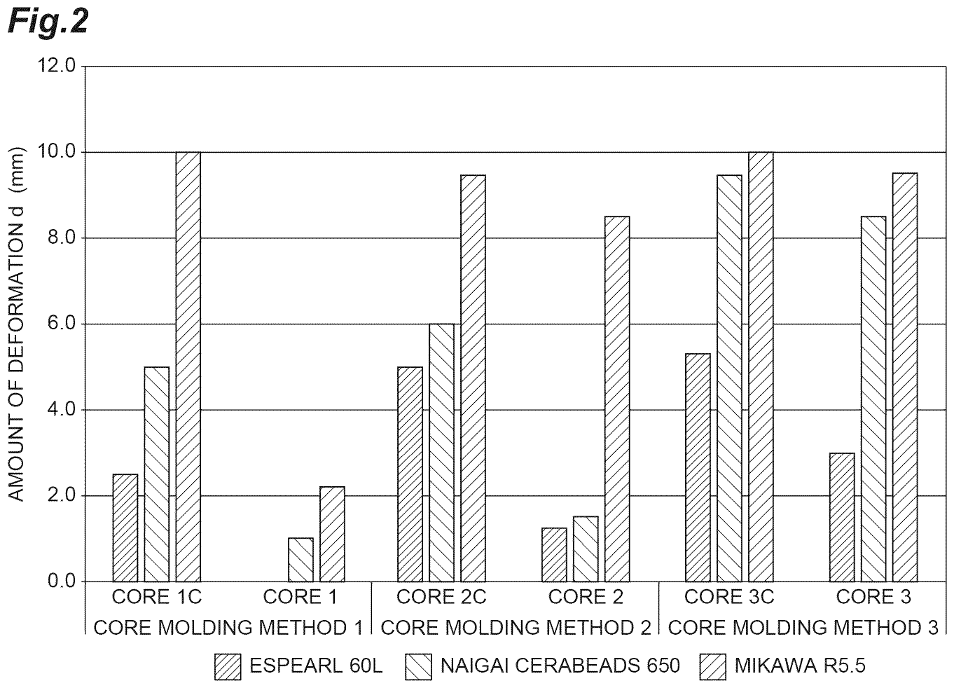

FIG. 2 is a graph showing a relationship between the presence or absence of addition of aluminum silicate to a water glass binder and the amount of deformation of the through hole. It is noted that the amount of deformation d was 0 mm in the example using the ESPEARL 60L of the core 1 (not shown in the drawing). As shown in FIG. 2, it has been found that as compared with the case where water glass No. 1 is used, the deformation of the through hole can be greatly suppressed by the water glass binder according to the present disclosure. The water glass binder according to the present disclosure has excellent heat resistance, and thus it is possible to manufacture a casting with high dimensional accuracy.

What is claimed is:

1. A binder for molding a casting mold, comprising:
water glass, and:
aluminum silicate dissolved in the water glass,
wherein the binder for molding a casting mold contains 2 to 15 parts by mass of the aluminum silicate with respect to 100 parts by mass of a solid content of the water glass.

2. The binder for molding a casting mold, according to claim 1, wherein the binder for molding a casting mold contains 40% to 55% by mass of the solid content of the water glass and the aluminum silicate.

3. The binder for molding a casting mold, according to claim 1, wherein the aluminum silicate is synthetic aluminum silicate.

4. A composition for molding a casting mold, comprising:
fireproof inorganic particles and:
the binder for molding a casting mold according to claim 1.
